(19) United States
(12) Patent Application Publication
(10) Pub. No.: US 2014/0084803 A1
(43) Pub. Date: Mar. 27, 2014

(54) LUMINAIRE AND OPERATION DEVICE

(71) Applicant: Toshiba Lighting & Technology Corporation, Kanagawa-ken (JP)

(72) Inventors: Toru ISHIKITA, Kanagawa (JP); Koji SUZUKI, Kanagawa (JP); Toshihiko SASAI, Kanagawa (JP); Masayuki TANAKA, Kanagawa (JP); Toshiaki TAKAHASHI, Kanagawa (JP)

(73) Assignee: Toshiba Lighting & Technology Corporation, Kanagawa-ken (JP)

(21) Appl. No.: 13/964,757

(22) Filed: Aug. 12, 2013

(30) Foreign Application Priority Data
Sep. 24, 2012 (JP) 2012-210009

(51) Int. Cl. H05B 37/02

(52) U.S. Cl. CPC H05B 37/02; H05B 37/0209
USPC 315/224; 315/291; 315/307

(57) ABSTRACT

In an operation device, a control unit is configured to be capable of receiving at least two operation patterns. A control unit keeps a switch off for a period of length corresponding to an operation pattern detected by a detecting unit. In a luminaire, when the length of a period in which a power level detected by a detecting unit falls is included in a first time range, a control unit stops power supply to a lighting unit while maintaining power supply to a communication unit.

### CROSS-REFERENCE TO RELATED APPLICATION

This application is based upon and claims the benefit of priority from Japanese Patent Application No. 2012-210009 filed on Sep. 24, 2012, the entire contents of which are incorporated herein by reference.

### FIELD

Embodiments described herein relate generally to a luminaire and an operation device.

### BACKGROUND

There has been known a luminaire including a communication unit and lit or extinguished on the basis of a control signal transmitted from a terminal such as a remote controller and received by a communication unit. Such a luminaire can be lit or extinguished not only by operation by the terminal but also by supplying electric power to the luminaire or stopping the supply of the electric power with an operation unit disposed on a wall or the like.

However, when the luminaire in the past is changed to an extinguished state by operation on the operation unit, since power supply to the communication unit is also stopped, the operation by the terminal cannot be performed. That is, when the luminaire in the past is changed to the extinguished state by the operation on the operation unit, convenience for a user is deteriorated.

### BRIEF DESCRIPTION OF THE DRAWINGS

FIG. 1 is a diagram of an example of a lighting system according to a first embodiment;

FIG. 2 is a diagram of an example of an operation device according to the first embodiment;

FIG. 3 is a diagram of an example of a luminaire according to the first embodiment;

FIG. 4 is a diagram of an example of an operation device according to a second embodiment;

FIG. 5 is a diagram of an example of a luminaire according to the second embodiment;

FIG. 6 is a diagram of an example of a lighting system according to a third embodiment;

FIG. 7 is a diagram of an example of a lighting control device according to a third embodiment;

FIG. 8 is a diagram of an example of a lighting control device according to a fourth embodiment;

FIG. 9 is a diagram of an example of a lighting system according to a sixth embodiment; and

FIG. 10 is a diagram of an example of an operation device according to the sixth embodiment.

### DETAILED DESCRIPTION

In general, according to an embodiment, there is provided a luminaire and an operation device that improve convenience for a user.

In a first embodiment explained below, in an operation device 10 in a lighting system 1, a control unit 14 keeps a switch 15 off for a period of length corresponding to an operation pattern detected by a detecting unit 13.

On the other hand, in a luminaire 20, when the length of a period in which a power level detected by a detecting unit 21 falls is included in a first time range, a control unit 22 stops power supply to a lighting unit 25 while maintaining power supply to a communication unit 26.

In a second embodiment, a communication unit is provided in an operation device rather than in a luminaire.

In a third embodiment, functional units other than a lighting unit are provided in a lighting control device separated from a luminaire.

In a fourth embodiment, a communication unit is provided in an operation device rather than in a luminaire.

In a fifth embodiment, as a mode of a luminaire, a mode other than a full lighting mode and an extinguishing mode is introduced.

In a sixth embodiment, an operation device is connected to a terminal via a network.

Lighting systems, luminaires, and operation devices according to the embodiments are explained below with reference to the drawings. In the embodiments, components having the same functions are denoted by the same reference numerals and redundant explanation of the components is omitted.

### First Embodiment

Configuration of the Lighting System

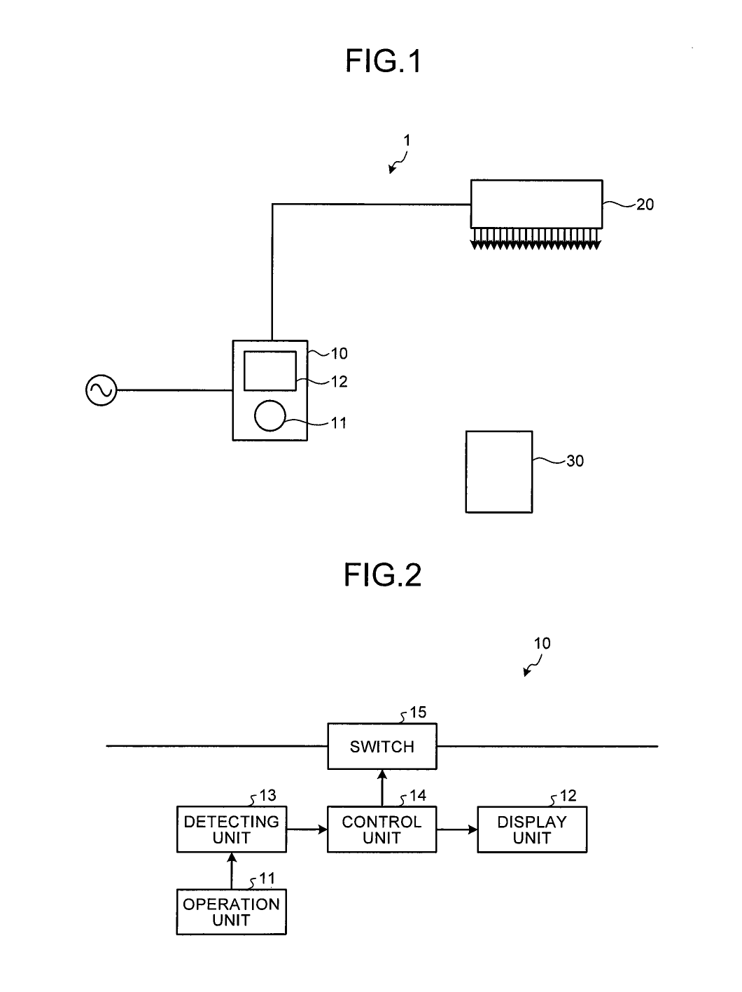

FIG. 1 is a diagram of an example of the lighting system according to the first embodiment. In FIG. 1, the lighting system 1 includes the operation device 10 connected to a power supply, the luminaire 20, and a terminal 30.

The operation device 10 includes an operation unit 11 and a display unit 12. The operation device 10 forms a control signal corresponding to an operation pattern of operation of the operation unit 11 by a user and transmits the formed control signal to the luminaire 20 via a power line. The operation device 10 displays display contents corresponding to the operation pattern on the display unit 12.

The terminal 30 transmits a control signal corresponding to operation by the user to the luminaire 20. The terminal 30 transmits the control signal through non-wired communication such as infrared communication or radio communication.

The luminaire 20 is connected to the operation device 10 via the power line. That is, electric power is supplied to the luminaire 20 via the operation device 10. The luminaire 20 performs operation such as lighting or extinguishing on the basis of the control signal transmitted from the operation device 10 or the terminal 30.

Configuration of the Operation Device

FIG. 2 is a diagram of an example of the operation device according to the first embodiment. In FIG. 2, the operation device 10 includes the operation unit 11, the display unit 12, the detecting unit 13, the control unit 14, and the switch 15.

The operation unit 11 is configured to be capable of receiving at least two operation patterns. The operation unit 11 includes, for example, a button. When the user depresses the button, the operation device 10 changes to a conduction state and an electric current flows into the detecting unit 13.

The detecting unit 13 detects an operation pattern of operation performed on the operation unit 11. For example, the detecting unit 13 measures the length of a period in which the electric current flows into the detecting unit 13. When the measured period length is equal to or larger than a first threshold and smaller than a second threshold, the detecting unit 13 detects “short press” as the operation pattern. When the measured period length is equal to or larger than the second threshold, the detecting unit 13 detects “long press” as the operation pattern.

The control unit 14 forms a control signal corresponding to the operation pattern detected by the detecting unit 13. Specifically, the control unit 14 keeps the switch 15 off for a period of length corresponding to the operation pattern detected by the detecting unit 13 and thereafter turns on the switch 15. That is, the operation device 10 configures a one-shot off switch. Consequently, a power level supplied to the luminaire 20 falls by the length corresponding to the operation pattern. That is, the length of a period of the fall of the power level supplied to the luminaire 20 is used as a control signal. The length of the period in which the switch 15 is kept off, that is, the length of the period of the fall of the power level is desirably equal to or longer than 10 milliseconds and equal to or shorter than 100 milliseconds. It is possible to distinguish a short break due to thunder or the like and the control signal by setting the length of the period of the fall of the power level to 10 milliseconds or longer. In the case of the short press, the switch 15 is kept off for a first period. In the case of the long press, the switch. 15 is kept off for a second period longer than the first period. The length of the first period and the length of the second period may be able to be changed by operating the operation device 10. In this case, the control unit 14 receives a setting change signal from the operation unit 11 and changes the length of the first period and the length of the second period on the basis of the setting change signal. The control unit 14 transmits the setting change signal to the luminaire 20.

In the case of the short press, the control unit 14 causes the display unit 12 to display information indicating “in communication operation”. In the case of the long press, the control unit 14 causes the display unit 12 to display information indicating “in power supply shutdown”.

The switch 15 is turned on and off according to the control by the control unit 14. An input end of the switch 15 is connected to the power supply. An output end of the switch 15 is connected to the luminaire 20.

Configuration of the Luminaire

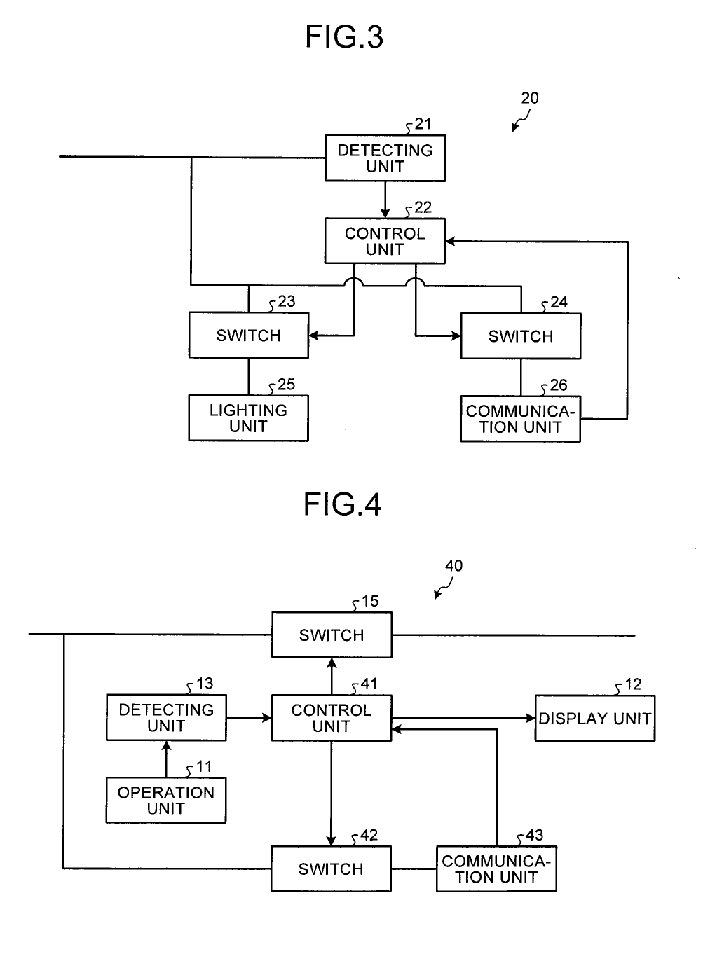

FIG. 3 is a diagram of an example of the luminaire according to the first embodiment. In FIG. 3, the luminaire 20 includes the detecting unit 21, the control unit 22, switches 23 and 24, the lighting unit 25, and the communication unit 26. The luminaire 20 is used while being connected to the operation device 10 via the power line.

The detecting unit 21 is connected to the power line connected to the operation device 10. The detecting unit 21 detects a control signal transmitted from the operation device 10. Specifically, the detecting unit 21 measures the length of a period in which the level of electric power received via the operation device 10 is equal to or smaller than a threshold and outputs a measured value to the control unit 22.

When the measured value received from the detecting unit 21 is included in a first time range, that is, when the measured value received from the detecting unit 21 corresponds to the first period explained above, the control unit 22 turns off the switch 23 while keeping the switch 24 on. On the other hand, when the measured value received from the detecting unit 21 is included in a second time range, that is, when the measured value received from the detecting unit 21 corresponds to the second period explained above, the control unit 22 turns off both the switches 24 and 23. The first time range and the second time range may be able to be changed according to the operation of the operation device 10 or the terminal 30. In this case, the control unit 22 changes the first time range and the second time range on the basis of a setting change signal received from the operation device 10 or a setting change signal received from the terminal 30 via the communication unit 26.

The control unit 22 receives a control signal via the communication unit 26 and turns on or off the switch 23 and the switch 24 according to contents indicated by the received control signal

The switch 23 and the switch 24 are turned on and off according to the control by the control unit 22. An input end of the switch 23 is connected to the power line connected to the operation device 10. An output end of the switch 23 is connected to the lighting unit 25. An input end of the switch 24 is connected to the power line connected to the operation device 10. An output end of the switch 24 is connected to the communication unit 26.

The lighting unit 25 is connected to the output end of the switch 23. The lighting unit 25 receives the supply of electric power to be lit when the switch 23 is on. The lighting unit 25 is, for example, an LED (Light Emitting Diode).

The communication unit 26 is connected to the output end of the switch 24. The communication unit 26 operates when the switch 24 is on. The communication unit 26 is, for example, an infrared receiving unit or a radio receiving unit. The communication unit 26 receives a control signal transmitted from the terminal 30 and outputs the control signal to the control unit 22.

Operation of the Lighting System

The operation of the lighting system having the configuration explained above is explained.

Since there is little need for remotely operating a light during sleep at night, it is a waste of electric power to continue to supply the electric power to the communication unit 26. Therefore, the user performs long-press operation to thereby change the lighting unit 25 and the communication unit 26 to a non-operation state. That is, when the user performs the long-press operation, electric power with the level fallen by the second period is output from the operation device 10 to the luminaire 20. The detecting unit 21 of the luminaire 20 detects the level fall of the second period. The control unit 22 turns off both the switches 23 and 24. Consequently, both of the lighting unit 25 and the communication unit 26 change to the non-operation state.

In this state, the lighting unit 25 cannot be lit according to the operation of the terminal 30. Therefore, the user goes to the operation device 10 and operates the operation device 10 to light the lighting unit 25.

Therefore, even if a light is extinguished for power saving, when it is highly likely that the light is lit by the operation of the terminal 30 soon, the user performs short-press operation to change the lighting unit 25 to the non-operation state while keeping the communication unit 26 in the operation state. That is, when the user performs the short press operation, electric power with the level fallen by the first period is output from the operation device 10 to the luminaire 20. The detecting unit 21 of the luminaire 20 detects the level fall of the first period. The control unit 22 turns off the switch 23. Consequently, the lighting unit 25 changes to the non-operation state.

As explained above, according to this embodiment, in the luminaire 20, when the length of the period in which the power level detected by the detecting unit 21 falls is included in the first time range, the control unit 22 stops the power supply to the lighting unit 25 while maintaining the power supply to the communication unit 26.

Consequently, it is possible to change the lighting unit 25 to the non-operation state while maintaining a state in which the remote operation for the luminaire 20 is possible. Therefore, it is possible to improve convenience for the user while realizing power saving. Further, since a state change of a power level can be used as a control signal, it is unnecessary to lay a control line anew and it is possible to simplify the system configuration.

The first time range is desirably set to be equal to or longer than 10 milliseconds and shorter than 100 milliseconds. Consequently, it is possible to distinguish the control signal from a fall of a power level caused by a short break due to thunder or the like.

The control unit 22 changes the first time range on the basis of a setting change signal. Consequently, it is possible to set the first time range to a suitable value.

In the operation device 10, the control unit 14 turns off the switch 15 for a period of length corresponding to an operation pattern detected by the detecting unit 13.

Consequently, it is possible to use the length of a period of the fall of the power level as a control signal. Therefore, it is unnecessary to lay a control line anew and it is possible to simplify the system configuration.

Candidates of the operation pattern detected by the detecting unit 13 include a first pattern for depressing the operation unit 11 for a first period, i.e., the short-press operation, and a second pattern for depressing the operation unit 11 for a second period longer than the first period, i.e., the long-press operation.

The length of the period in which the switch 15 is kept off is desirably equal to or longer than 10 milliseconds and shorter than 100 milliseconds. Consequently, it is possible to distinguish the control signal from a fall of a power level caused by a short break due to thunder or the like.

The control unit 14 changes, on the basis of a setting change signal, a setting value of the length of the period in which the switch 15 is kept off. Consequently, it is possible to set the setting value of the length of the period in which the switch 15 is kept off to a suitable value.

### Second Embodiment

In a second embodiment, a communication unit is provided in an operation device rather than in a luminaire. The configuration of a lighting system in the second embodiment is the same as the configuration in the first embodiment.

Configuration of the Operation Device

FIG. 4 is a diagram of an example of the operation device according to the second embodiment. In FIG. 4, an operation device 40 includes a control unit 41, a switch 42, and a communication unit 43.

In both the case of the short-press operation and the long-press operation, the control unit 41 keeps the switch 15 off for the first period. Consequently, a period of a fall of a power level is formed. The period of a fall of a power level is used as a control signal and a luminaire 50 is extinguished. However, in the case of the long-press operation, the control unit 41 turns off the switch 42. Consequently, power supply to the communication unit 43 is stopped. The length of the first period and the length of the second period may be able to be changed according to the operation of the operation device 10 or the terminal 30. In this case, the control unit 41 changes the length of the first period and the length of the second period on the basis of a setting change signal received from the operation unit 11 or a setting change signal received from the terminal 30 via the communication unit 43.

An input end of the switch 42 is connected to the power supply and an output end of the switch 42 is connected to the communication unit 43. When the long-press operation is performed, the switch 42 receives a control signal from the control unit 41 and changes to an OFF state. Consequently, the power supply to the communication unit 43 is stopped.

The communication unit 43 is connected to the output end of the switch 42. The communication unit 43 operates when the switch 42 is on. The communication unit 43 is, for example, an infrared receiving unit or a radio receiving unit. The communication unit 43 receives a control signal transmitted from the terminal 30 and outputs the control signal to the control unit 41.

Configuration of the Luminaire

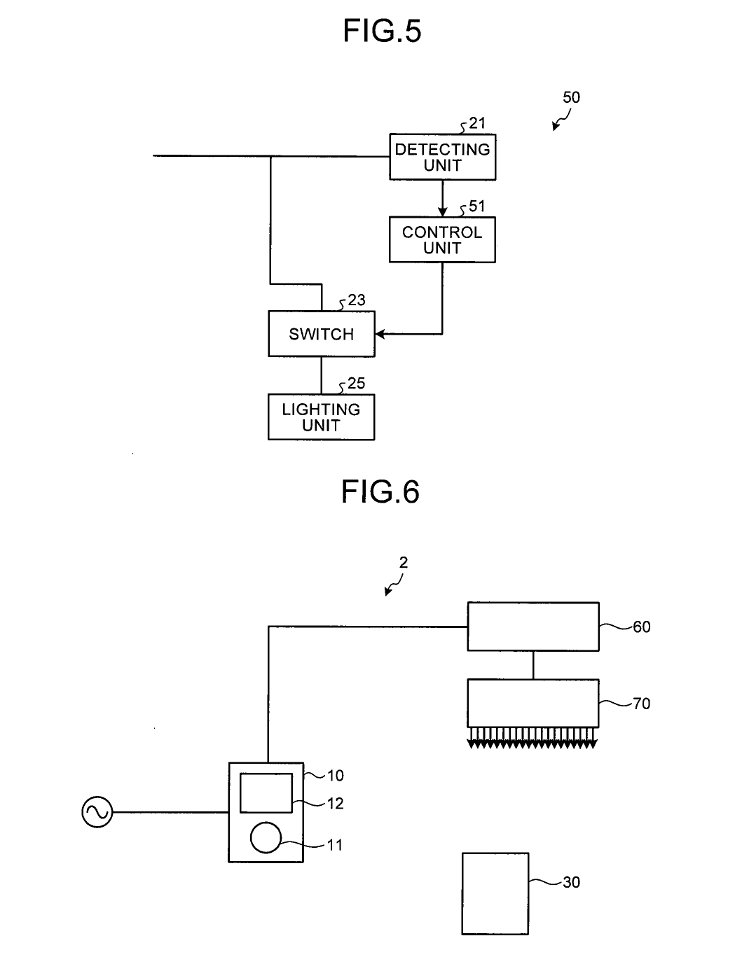

FIG. 5 is a diagram showing an example of the luminaire according to the second embodiment. In FIG. 5, the luminaire 50 includes a control unit 51.

When a measured value received from the detecting unit 21 corresponds to the first period explained above, the control unit 51 turns off the switch 23. The first time range and the second time range may be able to be changed according to the operation of the operation device 10 or the terminal 30. In this case, the control unit 51 changes the first time range and the second time range on the basis of a setting change signal received from the operation device 10.

As explained above, according to this embodiment, in the operation device 40, when the short-press operation is detected, the control unit 41 keeps the switch 15 off for the first period while maintaining the power supply to the communication unit 43.

Consequently, it is possible to change the lighting unit 25 to the non-operation state while maintaining a state in which remote operation for the luminaire 20 is possible. Therefore, it is possible to improve convenience for the user while realizing power saving. Further, since a state change of the power level can be used as a control signal, it is unnecessary to lay a control line anew and it is possible to simplify the system configuration.

### Third Embodiment

In the first embodiment, the detecting unit, the control unit, and the lighting unit are provided in the luminaire. On the other hand, in a third embodiment, functional units other than a lighting unit is provided in a lighting control device separated from a luminaire.

Configuration of a Lighting System

FIG. 6 is a diagram of an example of a lighting system according to a third embodiment. In FIG. 6, a lighting system 2 includes a lighting control device 60 and a luminaire 70.

The lighting control device 60 is connected to the operation device 10 via a power line. The lighting control device 60 lights or extinguishes the luminaire 70 on the basis of a control signal transmitted from the operation device 10 or the terminal 30.

Configuration of the Lighting Control Device

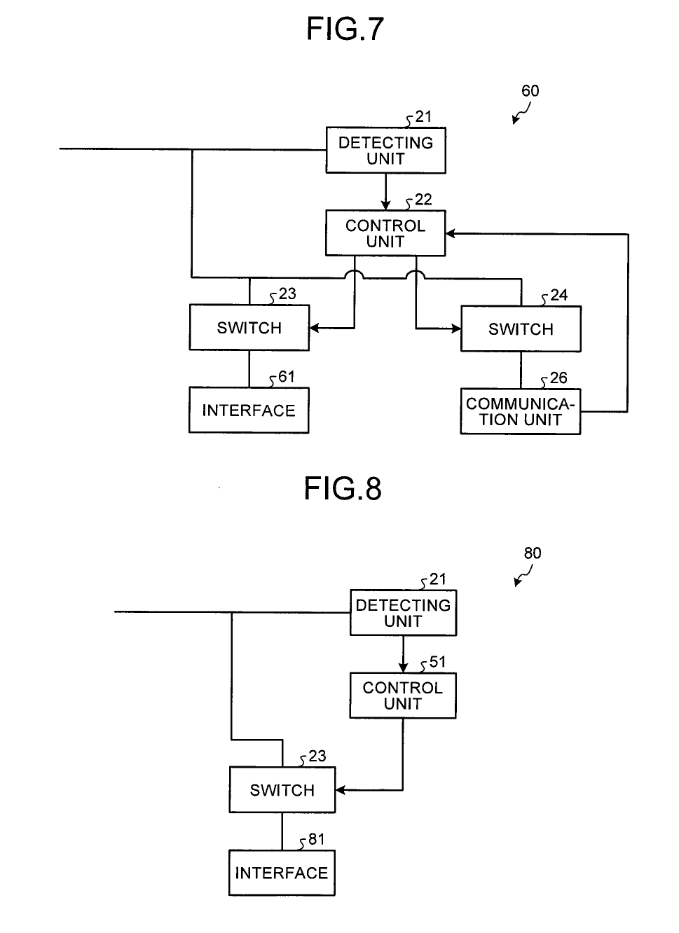

FIG. 7 is a diagram of an example of the lighting control device according to the third embodiment. In FIG. 7, the lighting control device 60 includes an interface 61. The lighting control device 60 configures a lighting control system in conjunction with the operation device 10. When the luminaire 70 is, for example, a ceiling light, the lighting control device 60 is set on the ceiling.

The interface 61 is connected to the output end of the switch 23. The interface 61 is configured to enable the luminaire 70 to be attached to the interface 61. When the switch 23 is turned on, electric power is supplied to the luminaire 70 attached to the interface 61.

As explained above, according to this embodiment, in the lighting control device 60, when the length of a period in which a power level detected by the detecting unit 21 falls is included in the first time range, the control unit 22 stops power supply to the interface 61 while maintaining power supply to the communication unit 26.

Consequently, it is possible to change the luminaire 70 to the non-operation state while maintaining a state in which remote operation for the luminaire 70 is possible. Therefore, it is possible to improve convenience of the user while realizing power saving. Further, since a state change of a power level can be used as a control signal, it is unnecessary to lay a control line anew and it is possible to simplify the system configuration.

### Fourth Embodiment

In the third embodiment, the communication unit is provided in the lighting control device. On the other hand, in a fourth embodiment, as in the second embodiment, the communication unit is provided in the operation device. The configuration of a lighting system according to the fourth embodiment is the same as the configuration in the third embodiment.

Configuration of a Lighting Control Device

FIG. 8 is a diagram of an example of a lighting control device according to the fourth embodiment. In FIG. 8, a lighting control device 80 includes an interface 81. The lighting control device 80 configures a lighting control system in conjunction with the operation device 10.

The interface 81 is connected to the output end of the switch 23. The interface 81 is configured to enable the luminaire 70 to be attached to the interface 81. When the switch 23 is turned on, electric power is supplied to the luminaire 70 attached to the interface 81.

As explained above, according to this embodiment, in the lighting control device 80, when the length of a period in which a power level detected by the detecting unit 21 falls is included the first time range, the control unit 51 stops power supply to the interface 81.

Consequently, since the luminaire 70 can be changed to the non-operation state, it is possible to realize power saving. Further, since a state change of a power level can be used as a control signal, it is unnecessary to lay a control line anew and it is possible to simplify the system configuration.

### Fifth Embodiment

In the first to fourth embodiments, concerning the modes of the luminaire, the two modes, i.e., the lighting mode and the extinguishing mode are explained. In a fifth embodiment, a fourth mode other than the lighting mode, the extinguishing mode (communication unit ON), and the extinguishing mode (communication unit OFF) is provided. The fourth mode can be applied to all the first to fourth embodiments. However, in particular, as an example, the fourth mode is applied to the lighting system according to the first embodiment.

In the operation device 10 in the fifth embodiment, the detecting unit 13 detects an operation pattern of operation performed on the operation unit 11. Specifically, a range of time length equal to or larger than the first threshold and smaller than the second threshold is divided into a plurality of time ranges. The detecting unit 13 measures the length of a period in which an electric current flows into the detecting unit 13. The detecting unit 13 detects a time range including measured period length. Consequently, it is possible to detect an operation pattern corresponding to the detected time range.

The control unit 14 forms a control signal corresponding to the operation pattern detected by the detecting unit 13. Specifically, the control unit 14 turns off the switch 15 for a period of length corresponding to the operation pattern detected by the detecting unit 13 and thereafter turns on the switch 15.

In the luminaire 20 according to the fifth embodiment, in a state of the lighting mode (a first mode), when a measured value received from the detecting unit 21 is included in a first time range, as in the first embodiment, the control unit 22 turns off the switch 23 while keeping the switch 24 on (a second mode). When the measured value received from the detecting unit 21 is included in a second time range not overlapping the first time range, the control unit 22 changes the color (e.g., a light bulb color, white, and pink) of the lighting unit 25 while keeping the switch 24 and the switch 23 on (a fourth mode). Alternatively, when the measured value received from the detecting unit 21 is included in the second time range not overlapping the first time range, the control unit 22 changes the lighting unit 25 to a power saving lighting mode while keeping the switch 24 and the switch 23 on (the fourth mode). The first time range and the second time range are compared with a power fall time and are different from the plurality of time ranges used in the detecting unit 13.

As explained above, according to this embodiment, in the luminaire 20, when the length of a period in which a level of electric power detected by the detecting unit 21 falls is included in the second time range not overlapping the first time range, the control unit 22 changes the lighting unit 25 from the present lighting mode to another lighting mode.

Consequently, it is possible to finely set the modes other than the lighting mode and the extinguishing mode. Therefore, it is possible to improve convenience for the user.

### Sixth Embodiment

In a sixth embodiment, an operation device including a communication unit and a terminal are connected via a base station and a network.

Configuration of a Lighting System

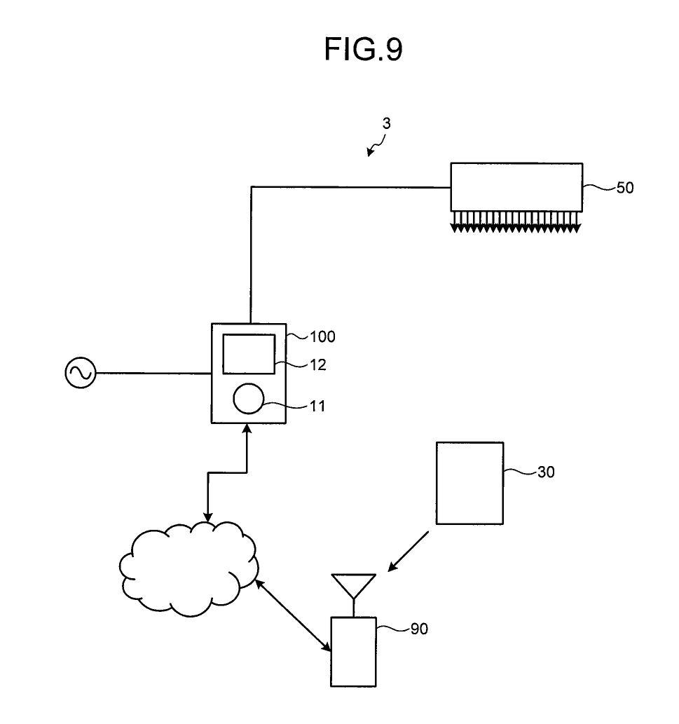

FIG. 9 is a diagram of an example of a lighting system according to the sixth embodiment. In FIG. 9, a lighting system 3 includes a base station 90 and an operation device 100.

The terminal 30 is connected to the operation device 100 via the base station 90 and the network.

When operated by the user, the terminal 30 transmits a command signal corresponding to an operation pattern to the base station 90 by radio. The terminal 30 transmits a setting change signal to the base station 90 by radio. The command signal and the setting change signal are transmitted to the operation device 100 via the base station 90 and the network.

The operation device 100 receives the command signal transmitted from the terminal 30 and forms a control signal corresponding to the received command signal.

Configuration of the Operation Device

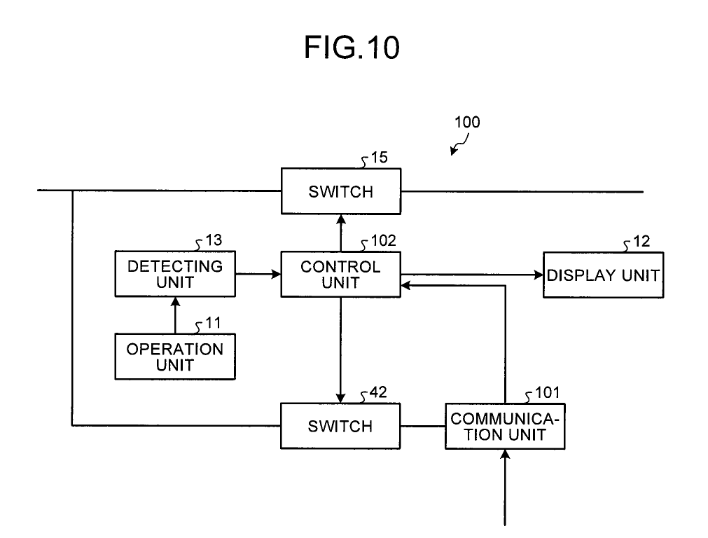

FIG. 10 is a diagram of an example of the operation device according to the sixth embodiment. In FIG. 10, the operation device 100 includes a communication unit 101 and a control unit 102.

The communication unit 101 has a function same as the function of the communication unit 43 in the second embodiment. Further, the communication unit 101 receives the command signal transmitted from the terminal 30 via the base station 90 and the network and outputs the command signal to the control unit 102.

The control unit 102 has a function same as the function of the control unit 41 in the second embodiment. Further, the control unit 102 forms a control signal corresponding to the command signal received from the communication unit 101. That is, since the command signal is different depending on an operation pattern of the terminal 30, a control signal corresponding to the operation pattern is formed.

Specifically, when receiving a command signal corresponding to a first operation pattern, as in the case of the short-press operation in the second embodiment, the control unit 102 keeps the switch 15 off for the first period. In this case, the switch 42 is kept on without being turned off.

When receiving a command signal corresponding to a second operation pattern, as in the case of the long-press operation in the second embodiment, the control unit 102 keeps the switch 15 off for the first period and turns off the switch 42. Consequently, the luminaire 50 is extinguished and power supply to the communication unit 43 is stopped.

When receiving a command signal corresponding to a third operation pattern, as in the case of the fifth embodiment, the control unit 102 forms a control signal for switching the mode of the luminaire 50 to the fourth mode and transmits the control signal to the luminaire 50.

As explained above, according to this embodiment, it is possible to use a network terminal such as a smartphone as the terminal 30.

In the above explanation, the lighting system equivalent to the lighting system in which the operation device in the second embodiment is connected to the network is explained. However, the lighting system is not limited to this. The operation device in the fourth embodiment may be connected to the network.

As explained above, according to the first to sixth embodiments, it is possible to improve convenience for the user.

### Other Embodiments

In the example explained in the first to sixth embodiments, the operation patterns are distinguished according to the depression times of the operation unit. However, a method of distinguishing the operation patterns is not limited to this. For example, a plurality of switch buttons may be provided in the operation unit and the operation patterns may be associated with the respective buttons. Alternatively, a switch button of the operation unit may be configured to be capable of transitioning to states in a plurality of stages and the operation patterns may be associated with the respective states.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A luminaire connected to a power supply via an operation device, the luminaire comprising:
a communication unit configured to receive a control signal from a terminal device;
a lighting unit configured to be lit using power supplied from the power supply through the operation device; and
a control unit configured to maintain the power supplied to the communication unit even when the power supplied to the lighting unit is cut off.

2. The luminaire according to claim 1, further comprising:
a detecting unit configured to detect a level of the power supplied thereto,
wherein the control unit is configured to cut off the power supplied to the lighting unit when a length of a time period during which the detected power level falls is greater than a first length.

3. The luminaire according to claim 2, wherein the control unit is configured to also cut off the power supplied to the communication unit when the length of the time period is greater than a second length.

4. The luminaire according to claim 3, wherein the control unit is configured to change the first length in response to a setting change signal.

5. The luminaire according to claim 4, wherein the setting change signal is received from the operation device.

6. The luminaire according to claim 1, wherein the control unit is configured to cause a color of the light emitted from the lighting unit to be changed when a length of a time period during which the detected power level falls is within a predetermined range of time periods.

7. The luminaire according to claim 1, wherein the control unit is configured to cause a luminance of the light emitted from the lighting unit to be changed when a length of a time period during which the detected power level falls is within a predetermined range of time periods.

8. An operation device connected between a power supply and a luminaire, the operation device comprising:
an operation unit configured to receive inputs from a user;
a switch, one end of which is connected to the power supply, and another end of which is connected to the luminaire; and
a control unit configured to turn on the switch to supply power to the luminaire and to turn off the switch to cut off power to the luminaire for a first period of time in response to a first input and for a second period of time in response to a second input.

9. The operation device according to claim 8, further comprising:
a communication unit configured to receive a control signal from a terminal device, wherein
the control unit is configured to maintain power supplied to the communication unit even when the power supplied to the luminaire is cut off by turning off the switch.

10. The operation device according to claim 9, wherein
the control unit is configured to cut off the power supplied to the communication unit in response to either the first or second input.

11. The operation device according to claim 8, wherein the control unit is configured to change length of the first or second period of time in response to a setting change signal.

12. The operation device according to claim 11, wherein the setting change signal is received from the operation unit.

13. The operation device according to claim 8, wherein
the operation unit includes a structure that can be physically manipulated by the user,
each of the first and second inputs is provided by the structure being manipulated for a certain period of time.

14. The operation device according to claim 13, wherein
a period of time to provide the second input is longer than a period of time to provide the first input, and
the second period of time is longer than the first period of time.

15. A method for operating a lighting system including a light device having a lighting unit and a communication unit that is configured to receive a control signal from a terminal device, and an operation device connected to the lighting device, the method comprising:
detecting a level of power supplied to the lighting device;
cutting off the power supplied to the lighting unit when a length of a time period during which the detected power level falls is greater than a first length; and
maintaining the power supplied to the communication unit even when the power supplied to the lighting unit has been cut off.

16. The method according to claim 15, further comprising:
cutting off the power supplied to the communication unit when the length of the time period is greater than a second length.

17. The method according to claim 15, further comprising:
changing the first length in response to a setting change signal.

18. The method according to claim 17, wherein
the setting change signal is received from the operation device.

19. The method according to claim 15, further comprising:
changing a color of the light emitted from the lighting unit when a length of a time period during which the detected power level falls is within a predetermined range of time periods.

20. The method according to claim 15, further comprising:
changing a luminance of the light emitted from the lighting unit when a length of a time period during which the detected power level falls is within a predetermined range of time periods.
